(19) United States
(12) Patent Application Publication
(10) Pub. No.: US 2026/0204550 A1
(43) Pub. Date: Jul. 16, 2026

(54) CONDUCTIVE MATERIAL-CONTAINING ETHYLENE CARBONATE COMPOSITE, COMPOSITE ACTIVE MATERIAL PARTICLE, METHOD OF PRODUCING ACTIVE MATERIAL LAYER, AND METHOD OF MANUFACTURING ELECTRODE LAMINATE MODULE

(71) Applicant: TOYOTA JIDOSHA KABUSHIKI KAISHA, Toyota-shi (JP)

(72) Inventors: Atsushi SUGIHARA, Toyota-shi (JP); Jun IZUMI, Toyota-shi (JP); Satoshi NAKASHIMA, Toyota-shi (JP); Masashi UEDA, Toyota-shi (JP)

(73) Assignee: TOYOTA JIDOSHA KABUSHIKI KAISHA, Toyota-shi (JP)

(21) Appl. No.: 19/409,928

(22) Filed: Dec. 5, 2025

(30) Foreign Application Priority Data
Jan. 16, 2025 (JP) 2025-006355

(51) Int. Cl. H01M 4/36; H01M 4/58; H01M 4/60

(52) U.S. Cl. CPC H01M 4/366; H01M 4/58; H01M 4/60

(57) ABSTRACT

The conductive material-containing ethylene carbonate composite of the present disclosure contains ethylene carbonate in a solid state and a conductive material dispersed in the ethylene carbonate in the solid state. In addition, the composite active material particles of the present disclosure include the conductive material-containing ethylene carbonate composite described in the present disclosure, and the first active material particles.

### CROSS-REFERENCE TO RELATED APPLICATION

This application claims priority to Japanese Patent Application No. 2025-006355 filed on Jan. 16, 2025. The disclosure of the above-identified application, including the specification, drawings, and claims, is incorporated by reference herein in its entirety.

### BACKGROUND

### 1. Technical Field

The present disclosure relates to a conductive material-containing ethylene carbonate composite, composite active material particle, a method of producing an active material layer, and a method of manufacturing an electrode laminate module.

### 2. Description of Related Art

In an electrode laminate module, an electrode laminate in which a positive electrode current collector layer, a positive electrode active material layer, a separator layer or a solid electrolyte layer, a negative electrode active material layer, and a negative electrode current collector layer are laminated in this order is generally accommodated in an exterior container or the like. Particles of Si, SiC, or the like, which is occasionally contained in the negative electrode active material layer as negative electrode active material particles, are greatly expanded and contracted by charging and discharging, thereby causing cracking of the active material layer, generation of liquid leakage of the electrolyte, reduction of the life of the battery, and the like. Therefore, in recent years, various studies have been made in order to suppress the volume expansion of the electrode material even after repeated charging and discharging from the viewpoint of the safety of use of the battery.

For example, Japanese Unexamined Patent Application Publication No. 2018-170246 (JP 2018-170246 A) discloses a composite active material for a lithium secondary battery, having Si or Si alloy, and a void between a thin graphite layer and Si or Si alloy, or between a thin graphite layer and a thin graphite layer, or between Si or Si alloy and Si or Si alloy, and having a porosity of 2 to 50%. According to the composite active material for a lithium secondary battery described in JP 2018-170246 A, it is possible to fabricate an electrode material in which volume expansion is suppressed during charging and even after repeated charging and discharging, and it is possible to manufacture a lithium secondary battery that exhibits excellent cycle characteristics.

### SUMMARY

In the related art of increasing the porosity of the active material layer, it is possible to alleviate cracks or the like of the active material layer due to expansion and contraction of SiC particles or the like, while it is conceivable that SiC particles or the like become electrically isolated.

In view of the above, an object of the present disclosure is to provide a method of producing an active material layer that has a void and suppresses active material particles being electrically isolated.

The present disclosure achieves the above object by the following means.

### First Aspect

A conductive material-containing ethylene carbonate composite containing ethylene carbonate in a solid state and a conductive material dispersed in the ethylene carbonate in the solid state.

### Second Aspect

A composite active material particle including the conductive material-containing ethylene carbonate composite according to the first aspect and a first active material particle.

### Third Aspect

The composite active material particle according to the second aspect, further including a second active material particle disposed at a periphery.

### Fourth Aspect

A method of producing an active material layer, including:
providing an active material layer precursor containing the composite active material particle according to the second or third aspect; and
dissolving the ethylene carbonate in the composite active material particle.

### Fifth Aspect

A method of manufacturing an electrode laminate module, including the method according to the fourth aspect.

According to the present disclosure, it is possible to produce an active material layer that has a void and suppresses the active material particles being electrically isolated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for explaining the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Conductive Material-Containing Ethylene Carbonate Composite

The conductive material-containing ethylene carbonate composite of the present disclosure contains ethylene carbonate in a solid state and a conductive material dispersed in the ethylene carbonate in the solid state.

When the above-described conductive material-containing ethylene carbonate composite is used, it is possible to manufacture an active material layer having voids and suppressing the active material particles from being electrically isolated.

In the conventional method, the expansion and contraction of the negative electrode active material particles due to charge and discharge are suppressed by forming a void in the negative electrode active material layer, thereby suppressing the expansion and contraction of the battery. However, the present inventors have found that the active material particles may be electrically isolated by forming the voids, and thereby the battery performance may be deteriorated.

In contrast, according to the present disclosure, an active material layer precursor including composite active material particles is provided, and ethylene carbonate in the composite active material particles is dissolved. Here, the composite active material particles are formed by coating a conductive material-containing ethylene carbonate composite containing an ethylene carbonate and a conductive material dispersed in ethylene carbonate on the surface of the active material particles. As a result, the ethylene carbonate on the surface of the composite active material particles can be dissolved to form voids on the surface of the active material particles. For example, ethylene carbonate can be dissolved by injecting an electrolytic solution into the active material layer precursor, but the present disclosure is not limited thereto.

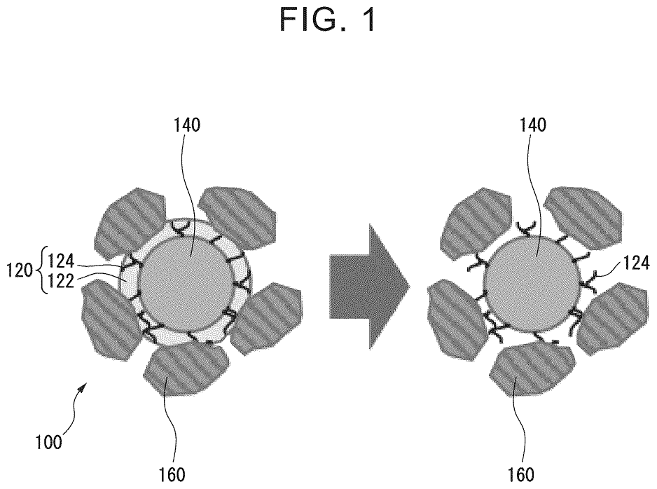

One embodiment of the present disclosure is illustrated in FIG. 1, but the present disclosure is not limited thereto. Composite active material particles 100 include conductive material-containing ethylene carbonate composite 120 containing ethylene carbonate 122 and conductive material 124 dispersed in ethylene carbonate 122, first active material particles 140, and second active material particles 160. The conductive material-containing ethylene carbonate composite 120 is coated around the first active material particles 140, and the second active material particles 160 are disposed around the conductive material-containing ethylene carbonate composite. Since the ethylene carbonate 122 contained in the conductive material-containing ethylene carbonate composite 120 is dissolved in the electrolytic solution by the injection of the electrolytic solution, a gap can be formed between the first active material particles 140 and the second active material particles 160. At this time, since the conductive material 124 is dispersed between the first active material particles 140 and the second active material particles 160, it is possible to suppress the first active material particles 140 being electrically isolated from the second active material particles 160.

In addition, an active material layer is formed using composite active material particles having a conductive material-containing ethylene carbonate composite, and ethylene carbonate in the composite active material particles is dissolved by liquid injection or the like. Accordingly, since the conductive material can be disposed in the formed voids, it is possible to suppress the active material particles from being electrically isolated.

The ethylene carbonate is in a solid state at room temperature (25° C.) and is an electrolyte component. Therefore, it is unnecessary to dry and remove the ethylene carbonate after the formation of the active material layer. Therefore, the present disclosure can be effectively utilized even when the entire process of forming the active material layer is performed as a dry film formation.

In the present disclosure, for example, ethylene carbonate is heated to a temperature equal to or higher than the melting point (36.4° C.) of ethylene carbonate to melt the ethylene carbonate. Subsequently, the conductive material can be dispersed in the ethylene carbonate by adding the conductive material to the ethylene carbonate dispersed by using the dispersing device, but the present disclosure is not limited thereto. The dispersing device is not particularly limited, and examples thereof include a homogenizer and the like.

### Conductive Material

In the present disclosure, the conductive material is contained in a conductive material-containing ethylene carbonate composite. In addition, the conductive material is dispersed in ethylene carbonate in a solid state.

In the present disclosure, a known conductive material of a secondary battery may be used as the conductive material. Specific examples of the conductive material include carbon materials such as Ketjen Black (KB), vapor-phase carbon fibers (VGCF), acetylene black (AB), carbon nanotubes (CNT), carbon nanofibers (CNF), carbon black, coke, and graphite. As the conductive material, a metal material capable of withstanding the environment when the battery is used can also be used. As the conductive material, only one kind may be used alone, or a combination of two or more kinds may be used. The shape of the conductive material may be various shapes such as a powder shape and a fiber shape.

In the present disclosure, the content of the conductive material in the conductive material-containing ethylene carbonate composite is not particularly limited, but may be 0.1% by mass or more, 0.5% by mass or more, 1.0% by mass or more, 3% by mass or more, or 5% by mass or more, and may be 20% by mass or less, 15% by mass or less, 10% by mass or less, 8% by mass or less, or 5% by mass or less.

### Composite Active Material Particles

The composite active material particles of the present disclosure include the conductive material-containing ethylene carbonate composite described in the present disclosure, and the first active material particles. For example, the conductive material-containing ethylene carbonate composite covers the surface of the first active material particles.

In the present disclosure, the composite active material particles may have second active material particles disposed around the periphery.

In the present disclosure, the coating thickness of the conductive material-containing ethylene carbonate composite is not particularly limited, but may be 3 μm or more, 5 μm or more, 10 μm or more, 20 μm or more, or 30 μm or more, and may be 500 μm or less, 300 μm or less, 200 μm or less, 100 μm or less, or 70 μm or less.

### Conductive Material-Containing Ethylene Carbonate Composite

For the conductive material-containing ethylene carbonate composite in the composite active material particles of the present disclosure, reference can be made to the above description regarding the conductive material-containing ethylene carbonate composite.

First and/or Second Active Material Particles

The first and/or second active material particles of the present disclosure are contained in the composite active material particles. With regard to the present disclosure, the first and/or second active material particles may be a positive electrode active material or a negative electrode active material, but it is preferable that the first and/or second active material particles be a negative electrode active material that expands and contracts by charging and discharging because the method of the present disclosure can be effectively used.

The material of the positive electrode active material is not particularly limited. The positive electrode active material may be, but is not limited to, lithium cobaltate (LiCoO₂), lithium nickelate (LiNiO₂), lithium manganate (LiMn₂O₄), lithium nickel cobalt manganate (NCM: LiCo_{1/3}Ni_{1/3}Mn_{1/3}O₂), lithium nickel cobalt aluminate (LiNi_{0.8}(CoAl)_{0.2}O₂), or hetero-element-substituted Li—Mn spinel of the composition represented by Li₁₊ₓMn_{2-x-y}M_{y}O₄ (where M is one or more metallic elements selected from Al, Mg, Co, Fe, Ni, and Zn), for example.

The material of the negative electrode active material is not particularly limited. The negative electrode active material may be, for example, metal lithium, and may be a material capable of occluding and releasing metal ions such as lithium ions. Examples of the material capable of occluding and releasing metal ions such as lithium ions include, but are not limited to, an alloy-based negative electrode active material, a carbon material, lithium titanate (Li₄Ti₅O₁₂), and silicon carbide (SiC).

The alloy-based negative electrode active material is not particularly limited, and examples thereof include a Si alloy-based negative electrode active material and a Sn alloy-based negative electrode active material. The Si alloy-based negative electrode active material includes silicon, silicon oxide, silicon carbide, silicon nitride or the like, or a solid solution thereof. Si alloy-based negative electrode active material may include a metallic element other than silicon, for example, iron (Fe), cobalt (Co), antimony (Sb), bismuth (Bi), lead (Pb), nickel (Ni), copper (Cu), zinc (Zn), germanium (Ge), indium (In), tin (Sn), titanium (Ti), and the like. Examples of Sn alloy-based negative electrode active material include tin, tin oxide, tin nitride, and the like, or a solid solution thereof. Sn alloy-based negative electrode active material may include a metallic element other than tin, for example, iron (Fe), cobalt (Co), antimony (Sb), bismuth (Bi), lead (Pb), nickel (Ni), copper (Cu), zinc (Zn), germanium (Ge), indium (In), tin (Sn), titanium (Ti), and the like.

The carbon material is not particularly limited, and examples thereof include hard carbon, soft carbon, graphite, and graphite.

The shape of the active material is not particularly limited, and may be, for example, particulate. When the active material is particulate, the particle diameter D₅₀ of the active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. Note that the particle diameter D₅₀ is the particle diameter (median diameter) at an integrated value of 50% in the volume-based particle size distribution determined by the laser diffraction/scattering method.

### Method for Producing Active Material Layer

The method of the present disclosure for producing an active material layer comprises providing an active material layer precursor comprising composite active material particles according to the present disclosure, and dissolving ethylene carbonate in the composite active material particles.

### Composite Active Material Particles

For the composite active material particles used in the method for producing an active material layer of the present disclosure, reference can be made to the above description regarding the composite active material particles.

### Active Material Layer

The active material layer of the present disclosure includes first and/or second active material particles and a conductive material. The active material layer may further contain at least one of a solid electrolyte and a binder, if necessary.

The content of the active material particles in the active material layer of the present disclosure is not particularly limited, but may be 1% by mass or more, 5% by mass or more, 10% by mass or more, 15% by mass or more, or 20% by mass or more. The content may be 50% by mass or less, 45% by mass or less, 40% by mass or less, 35% by mass or less, or 30% by mass or less.

For details of the active material particles contained in the active material layer in the present disclosure, the above description regarding the composite active material particles of the present disclosure can be referred to.

In the present disclosure, the thickness of the active material layer is not particularly limited. The thickness of the active material layer may be, for example, 0.1 μm or more, 1.0 μm or more, 3.0 μm or more, 5.0 μm or more, or 10 μm or more, and may be 1000 μm or less, 700 μm or less, 500 μm or less, 300 μm or less, or 100 μm or less.

In the present disclosure, the density of the active material layer is not particularly limited. The density of the active material layer may be 0.5 g/cm³ or more, 0.7 g/cm³ or more, 1.0 g/cm³ or more, 1.5 g/cm³ or more, or 2.0 g/cm³ or more, and may be 15 g/cm³ or less, 10 g/cm³ or less, 8 g/cm³ or less, 6 g/cm³ or less, 4 g/cm³ or less, or 3 g/cm³ or less.

In the present disclosure, a known solid electrolyte of a secondary battery may be used as the solid electrolyte optionally included in the active material layer. Examples of the solid electrolyte include an inorganic solid electrolyte such as a sulfide solid electrolyte, an oxide solid electrolyte, and a halide solid electrolyte, and an organic polymer electrolyte such as a polymer electrolyte. The electrolyte is preferably a sulfide solid electrolyte and an oxide solid electrolyte from the viewpoint of heat resistance. The solid electrolyte may be, for example, particulate. Only one type of solid electrolyte may be used alone, or two or more types of solid electrolytes may be used in combination.

Examples of the sulfide solid electrolyte include a solid electrolyte including an Li element, an X element (X is at least one of P, As, Sb, Si, Ge, Sn, B, and Al, Ga, In), and an S element. The sulfide solid electrolyte may further contain at least one of an O element and a halogen element. Examples of the halogen element include F element, Cl element, Br element, and I element. The sulfide solid electrolyte may be glass (amorphous) or glass ceramic. The sulfide solid electrolyte may be, but is not limited to, Li₂S—P₂S₅, LiI—Li₂S—P₂S₅, LiI—LiBr—Li₂S—P₂S₅, Li₂S—SiS₂, Li₂S—GeS₂, Li₂S—P₂S₅—GeS₂, for example.

The oxide solid-state electrolyte may be, but is not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃₋ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), for example. The oxide solid electrolyte may be amorphous or may be crystalline.

Examples of the halide solid-electrolyte include, but are not limited to, NaBH₄, NaB₁₀H₁₀, NaCB₉H₁₀, NaCB₁₁H₁₂, and NaB₁₂Cl₁₂.

Polymeric electrolytes include, but are not limited to, polyethylene oxide (PEO), polypropylene oxide (PPO), and copolymers thereof.

The content of the solid electrolyte optionally contained in the active material layer of the present disclosure is not particularly limited. The content of the solid electrolyte may be 1.0% by mass or more, 5.0% by mass or more, 10% by mass or more, 13% by mass or more, or 15% by mass or more, and may be 30% by mass or less, 20% by mass or less, 15% by mass or less, or 10% by mass or less.

In the present disclosure, as the binder optionally contained in the active material layer, a binder known as a binder used in a secondary battery may be used. Examples of the binder include styrene butadiene rubber (SBR), carboxymethyl cellulose (CMC), acrylonitrile butadiene rubber (ABR), butadiene rubber (BR), polyvinylidene fluoride (PVDF), and polytetrafluoroethylene (PTFE). Only one binder may be used alone, or a combination of two or more binders may be used.

The content of the binder optionally included in the active material layer of the present disclosure is not particularly limited. The content of the binder may be 0.1% by mass or more, 0.5% by mass or more, 1.0% by mass or more, 3.0% by mass or more, or 5.0% by mass or more, and may be 20% by mass or less, 15% by mass or less, 10% by mass or less, 8% by mass or less, or 5% by mass or less.

### Electrode Laminate Module and Method of Manufacturing the Same

The method of the present disclosure for manufacturing an electrode laminate module includes manufacturing an active material layer by the method described in the present disclosure.

### Electrode Laminate Module

In the electrode laminate module of the present disclosure, the electrode laminate including the active material layer manufactured by the method described in the present disclosure is accommodated in an exterior container or the like. In the present disclosure, the exterior container and the like are not particularly limited.

The present disclosure will be described in more detail with reference to the following examples, but the scope of the present disclosure is not limited by these examples.

### Example 1

### Preparation

Silicon carbide (SiC) and ethylene carbonate were prepared as active materials, and acetylene black was prepared as a conductive material. At this time, the mass ratio of silicon carbide, ethylene carbonate, and acetylene black was silicon carbide:ethylene carbonate:acetylene black=100:8:2.

### Preparation of Conductive Material-Containing Ethylene Carbonate Composite

The ethylene carbonate was warmed to 60° C. to melt the ethylene carbonate. After that, the ethylene carbonate was roasted at 60° C. and dispersed by a homogenizer, the acetylene black was gradually charged, and the acetylene black was dispersed in ethylene carbonate to obtain a conductive material-containing ethylene carbonate composite.

### Production of Composite Active Material Particles

Silicon carbide was introduced into the rolling fluidized bed of the rolling fluidized coating apparatus, and the silicon carbide was fluidized. Using a pump, the conductive material-containing ethylene carbonate composite was sprayed into a rolling fluidized bed by spraying, and the conductive material-containing ethylene carbonate composite was coated on the silicon carbide to obtain composite active material particles.

### Preparation of Electrode Stack and Measurement of Expansion Coefficient

A negative electrode active material layer containing a conductive material-containing ethylene carbonate composite and graphite at a ratio of 10:90 was prepared, and a battery containing the negative electrode active material layer was prepared. The battery was charged so that the charge rate (SOC) of the battery was 0% to 100%, and the expansion rate of the battery in the stacking direction before and after charging was measured.

### Comparative Example 1

A battery in Comparative Example 1 was prepared in the same manner as in Example 1, except that the conductive material-containing ethylene carbonate composite was made of silicon carbide, and the expansion coefficient of the battery was measured.

### Evaluation

The expansion coefficients of the batteries of Comparative Example 1 and Example 1 are shown in Table 1 below. Compared to the battery of Comparative Example 1 including the negative electrode active material layer containing silicon carbide and graphite, the battery of Example 1 including the conductive material-containing ethylene carbonate composite and the negative electrode active material layer containing graphite had a low expansion coefficient before and after charging. It was confirmed that expansion of the battery due to charge and discharge can be suppressed by providing the conductive material-containing ethylene carbonate composite and the negative electrode active material layer containing graphite.

TABLE 1

| | | Expansion |
|---|---|---|
| | Negative electrode active material layer | coefficient |
| Comparative | Silicon carbide + graphite | 6.3% |
| Example 1 | | |
| Example 1 | Conductive material-containing ethylene | 4.1% |
| | carbonate composite + graphite | |

What is claimed is:

1. A conductive material-containing ethylene carbonate composite comprising ethylene carbonate in a solid state and a conductive material dispersed in the ethylene carbonate in the solid state.

2. A composite active material particle comprising the conductive material-containing ethylene carbonate composite according to claim 1 and a first active material particle.

3. The composite active material particle according to claim 2, further comprising a second active material particle disposed at a periphery.

4. A method of producing an active material layer, comprising:
providing an active material layer precursor containing the composite active material particle according to claim 2; and
dissolving the ethylene carbonate in the composite active material particle.

5. A method of manufacturing an electrode laminate module, comprising producing an active material layer by the method according to claim 4.
